(19) United States
(12) Patent Application Publication
(10) Pub. No.: US 2007/0291609 A1
(43) Pub. Date: Dec. 20, 2007

(54) TILT ERROR DETECTING DEVICE, TILT CALIBRATING DEVICE, AND METHODS THEREOF FOR OPTICAL STORAGE DEVICE

(76) Inventors: Che-Sheng Lin, Taipei Hsien (TW); Ta-Chin Tseng, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/758,647

(22) Filed: Jun. 5, 2007

(30) Foreign Application Priority Data
Jun. 14, 2006 (TW) 095121244

(51) Int. Cl. G11B 7/00

(52) U.S. Cl. 369/53.19; 369/44.32

(57) ABSTRACT

The present invention discloses a tilt error detecting device for detecting a tilt error signal indicative of a tilt error between an optical disc and an optical pick-up head. The tilt error detecting device includes: a first combining module for generating a first level signal according to a first portion of a plurality of detecting signals which corresponds to a plurality of first detecting areas on a photo detector; a second combining module for generating a second level signal according to a second portion of the detecting signals which corresponds to a plurality of second detecting areas on the photo detector; and a calculating module coupled to the first combining module and the second combining module for generating the tilt error signal according to the first level signal and the second level signal.

### BACKGROUND OF THE INVENTION

1. Field of the Invention

The present invention relates to optical storage technology, and more particularly, to tilt error detection and tilt calibration.

2. Description of the Prior Art

Optical disc is a common storage medium nowadays. Digital information can be recorded on an optical disc adopting a scheme of pits and lands on a track of the optical disc. When the information recorded on the optical disc is read, an optical disc drive makes use of a laser light beam outputted by an optical pick-up, which focuses on the track of the optical disc, and the information stored in the optical disc is read by detecting the reflected light. Therefore, if an angle tilt exists between the optical disc and the light beam emitted by the optical pick-up head, servo control and the generation of the RF signal of the optical disc drive system would be affected during operation. Generally, the resulting of the tilt error is caused by a number of sources, such as defects of the optical disc, assembly errors of the internal components of the optical pick-up head, or run-out error incurred during disc's rotation.

Therefore, in order to solve the problem of tilt error, one of the conventional methods is by utilizing a jitter meter to perform measurement upon the RF signal, and changing the degree of tilt between the optical disc and the optical pick-up head until the jitter value of the RF signal is adjusted to a minimum, so as to achieve the goal of tilt error calibration. However, this conventional method is limited to apply to optical discs with data recorded thereupon, but cannot be used with blank optical discs.

In addition, there are also other conventional methods to achieve the same goal, for example, by observing the focus error (FE) signal or the tracking error (TE) signal when calibrating the tilt error. However, the method by observing the FE signal must be performed during focus off, and the object lens of the optical pick-up head needs to be moved continuously, which spends a significant amount of time. Moreover, because the FE signal and the TE signal are not sufficiently sensitive to changes in the tilt error, they do not serve as ideal indications for the tilt error. There are even conventional methods, which incorporate an additional optical component for the sole purpose of detecting tilt error (e.g., an optical component with an infrared ray scheme) in the optical pick-up head. However, this method increases the costs of the hardware and occupies more space, and because of the difficulty with layout design, the detecting optical component and the object lens of the optical pick-up head may not reside on the same plane, whereby measuring error is further incurred.

### SUMMARY OF THE INVENTION

It is an objective of the present invention to provide a tilt error detecting device, a tilt calibrating device, and related calibrating method, detecting tilt error by use of a plurality of detecting signals generated by a photo detector, which can detect and calibrate the tilt error even when an optical disc is not recorded with data (e.g., a blank optical disc).

It is another objective of the present invention to provide a tilt error detecting device, a tilt calibrating device, and related calibrating method, detecting tilt error by use of a plurality of detecting signals generated by a photo detector, which can achieve the goal of tilt error calibration without additional optical components for tilt error detection.

According to an aspect of the present invention, a tilt error detecting device is disclosed. The tilt error detecting device is utilized for detecting a tilt error signal indicative of a tilt error between an optical disc and an optical pick-up head. The optical pick-up head comprises a photo detector for generating a plurality of detecting signals according to a light signal reflected form the optical disc. The photo detector comprises a plurality of first detecting areas located at a first side and a plurality of second detecting areas located at a second side. The tilt error detecting device includes: a first combining module, coupled to the photo detector, for generating a first level signal according to a first portion of the detecting signals which corresponds to the first detecting areas on the photo detector; a second combining module, coupled to the photo detector, for generating a second level signal according to a second portion of the detecting signals which corresponds to the second detecting areas on the photo detector; and a calculating module, coupled to the first combining module and the second combining module, for generating the tilt error signal according to the first level signal and the second level signal.

According to another aspect of the present invention, a tilt calibrating device is disclosed. The tilt calibrating device is utilized for calibrating a tilt error between an optical disc and an optical pick-up head. The tilt calibrating device includes: a photo detector, a tilt error detecting device, a tilt control unit and an actuator. The photo detector is for generating a plurality of detecting signals according to a light signal reflected from the optical disc, and includes a plurality of first detecting areas located at a first side and a plurality of second detecting areas located at a second side. The tilt error detecting device, coupled to the photo detector, the tilt error detecting device, includes: a first combining module, coupled to the photo detector, for generating a first level signal according to a first portion of the detecting signals which corresponds to the first detecting areas on the photo detector; a second combining module, coupled to the photo detector, for generating a second level signal according to a second portion of the detecting signals which corresponds to the second detecting areas on the photo detector; and a calculating module, coupled to the first combining module and the second combining module, for generating a tilt error signal according to the first level signal and the second level signal. The tilt control unit, coupled to the calculating module, is for generating a control signal according to the tilt error signal. The actuator, coupled to the tilt control unit, is for adjusting the tilt error between the optical pick-up head and the optical disc according to the control signal.

According to another aspect of the present invention, a tilt error detecting method is disclosed. The tilt error detecting method is utilized for detecting a tilt error signal indicative of a tilt error between an optical disc and an optical pick-up head. The optical pick-up head includes a photo detector for generating a plurality of detecting signals according to a light signal reflected from the optical disc. The photo detector includes a plurality of first detecting areas located at a first side and a plurality of second detecting areas located at a second side. The tilt error detecting method includes: generating a first level signal according to a first portion of the detecting signals which corresponds to the first detecting areas on the photo detector; generating a second level signal according to a second portion of the detecting signals which corresponds to the second detecting areas on the photo detector; and generating the tilt error signal according to the first level signal and the second level signal.

According to another aspect of the present invention, a tilt calibrating method is disclosed. The tilt calibrating method is utilized for calibrating a tilt error between an optical disc and an optical pick-up head. The optical pick-up head includes a photo detector for generating a plurality of detecting signals according to a light signal reflected form the optical disc. The photo detector includes a plurality of first detecting areas located at a first side and a plurality of second detecting areas located at a second side. The tilt calibrating method includes: generating a first level signal according to a first portion of the detecting signals which corresponds to the first detecting areas on the photo detector; generating a second level signal according to a second portion of the detecting signals which corresponds to the second detecting areas on the photo detector; generating a tilt error signal according to the first level signal and the second level signal; generating a control signal according to the tilt error signal; and adjusting the tilt error between the optical pick-up head and the optical disc according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a tilt calibrating device according to an embodiment of the present invention.

FIG. 2 is a schematic diagram of the signal level of the combining signal SA+SD and the combining signal SB+SC shown in FIG. 1.

FIG. 3 shows a flowchart illustrating the tilt calibrating process performed by the tilt calibrating device shown in FIG. 1.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

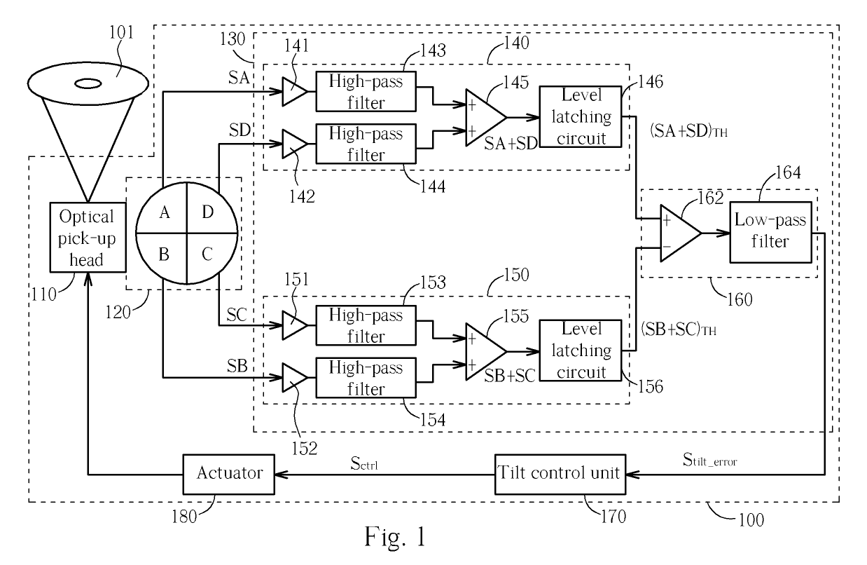

Please refer to FIG. 1. FIG. 1 is a block diagram of a tilt calibrating device 100 according to an embodiment of the present invention. The tilt calibrating device 100 includes an optical pick-up head 110 which includes a photo detector 120. The tilt calibrating device 100 further includes a tilt error detecting device 130, a tilt control unit 170, and an actuator 180. The tilt error detecting device 130 includes a plurality of combining modules 140, 150 and a calculation module 160. The combining module 140 includes a plurality of gain adjustors 141, 142, a plurality of high-pass filters 143, 144, an adder 145, and a level latching circuit 146. The combining modules 150 includes a plurality of gain adjustors 151, 152, a plurality of high-pass filters 153, 154, an adder 155, and a level latching circuit 156. Moreover, the calculation module 160 includes a subtractor 162 and a low-pass filter 164.

In this preferred embodiment, the optical pick-up head 110 emits laser light upon the track of the optical disc 101. The photo detector 120 then respectively generates the detecting signals SA, SB, SC, SD according to the reflected light detected by the various detecting areas A, B, C, D. Next, as shown in FIG. 1, the gain adjustors 141, 142 of the combining module 140 and the gain adjustors 151, 152 of the combining module 150 respectively amplify the detecting signals SA, SB, SC, SD. Then, the detecting signals SA, SB, SC, SD are respectively filtered by the high-pass filters 143, 144, 153, 154, to strip off their DC components. Please note that, in this preferred embodiment, the gain adjustors 141, 142, 151, 152 and the high-pass filters 143, 144, 153, 154 of the combining module 140, 150 are used for performing the signal processing upon the detecting signals SA, SB, SC, SD, rendering them suitable for subsequent operations, and are not meant to be taken as limitations of the present invention. Therefore, in other preferred embodiments, the above-mention components can be removed or replaced by other types of waveform adjusters, and these modifications also fall within the scope of the claimed invention.

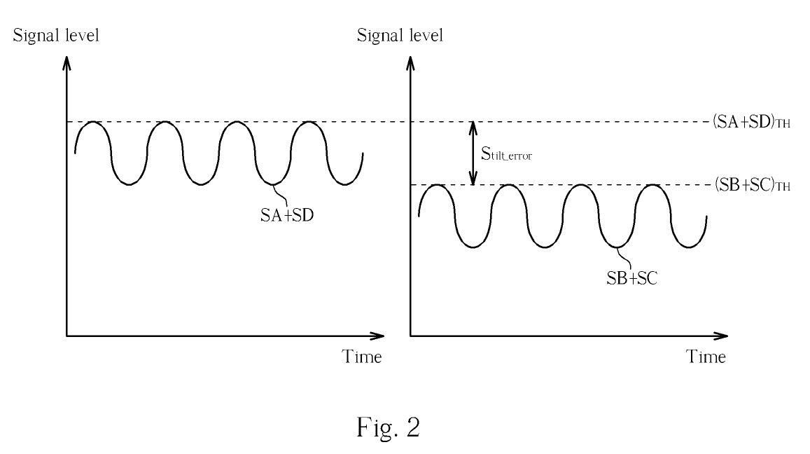

Next, the detecting signals SA, SB, SC, SD are respectively combined by the adder 145 of the combining module 140 and the adder 155 of the combining module 150. In this case, the adder 145 combines the detecting signals SA with SD to become a combining signal SA+SD, and the adder 145 combines the detecting signals SB with SC to become a combining signal SB+SC. Then level latching operation is performed respectively upon the combining signal SA+SD and the combining signal SB+SC by the level latching circuits 146 and 156. In this preferred embodiment, the level latching circuits 146 and 156 are top hold circuits. Please refer to FIG. 2 for detail illustration. FIG. 2 is a schematic diagram of the signal level of the combining signal SA+SD and the combining signal SB+SC shown in FIG. 1. Please note, as used herein, the term combining signal means the cumulative combination of two or more signals. As shown in FIG. 2, the level latching circuits 146 and 156 respectively latch the peak value (SA+SD)_{TH} of the combining signal SA+SD and the peak value (SB+SC)_{TH} of the combining signal SB+SC.

It should be note that the objective of the top hold circuits is to latch the maximum or peak value of the combining signal SA+SD and that of the combining signal SB+SC, in order to obtain a DC difference and then to force the different value to a maximum. However, utilizing other types of level latching circuits, for example, a bottom hold circuit or an averaging circuit, is also possible. If the level latching circuits 146, 156 are bottom hold circuits, the level latching circuits 146, 156 then latch the minimum value of the combining signal SA+SD and that of the combining signal SB+SC for subsequent processing by the calculation module 160. Alternately, if the level latching circuits 146, 156 are averaging circuits (e.g., low-pass filters), then the level latching circuits 146, 156 latch the average level of the combining signal SA+SD and that of the combining signal SB+SC for subsequent processing by the calculation module 160. Therefore, as long as certain levels of the combining signal SA+SD and those of the combining signal SB+SC are latched for the calculation module 160, the present invention is not limited to any specific circuit structure or component for the level latching devices 146, 156. Additionally, the purpose of this invention may still be achieved even when the level latching circuit is removed.

Next, subtraction is performed between the peak value (SA+SD)_{TH} and the peak value (SB+SC)_{TH} by the subtractor 162 of the calculation module 160 and the subtraction result is then filtered by the low-pass filter 164, to obtain its DC level, which is the tilt error signal Sₜᵢₗₜ_{_{—}}ₑᵣᵣₒᵣ of the present invention. Please note that, in this preferred embodiment of the present invention, although the subtraction result generated by the subtractor 162 is first filtered by the low-pass filter and then fed back for tilt calibration process, the present invention is not limited thereto. Even with the low-pass filter 164 removed, the goal of the present invention is still achievable.

To sum up, the tilt error signal Sₜᵢₗₜ_{_{—}}ₑᵣᵣₒᵣ of the present invention is indicative of the signal level difference between the combining signal SA+SD and the combining signal SB+SC. In other words, as the tilt error signal Sₜᵢₗₜ_{_{—}}ₑᵣᵣₒᵣ increases, so does the difference between the level value of the combining signal SA+SD and the combining signal SB+SC, which is an indication that the tilt in the optical disc drive system becomes larger. On the other hand, as the value of the tilt error signal Sₜᵢₗₜ_{_{—}}ₑᵣᵣₒᵣ approaches zero, the difference between the level value of the combining signal SA+SD and the combining signal SB+SC becomes less, which is an indication that the optical disc drive system is not presently affected by tilt error and therefore the tilt calibration operation completes. Therefore, the tilt control unit 170 outputs a control signal S_{ctrl} to the actuator 180 according to the received tilt error signal Sₜᵢₗₜ_{_{—}}ₑᵣᵣₒᵣ. The actuator 180 then adjusts the angle between the optical disc 101 and the optical pick-up head according to the control signal S_{ctrl}, so as to achieve tilt calibration.

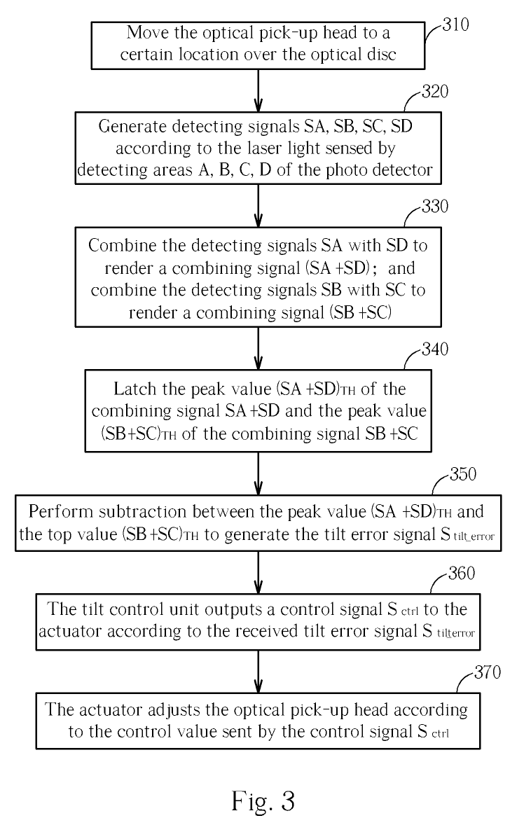

Please refer to FIG. 3. FIG. 3 shows a flowchart illustrating the tilt calibrating process performed by the tilt calibrating device 100 shown in FIG. 1. It is to be noted that the steps of the process need not be performed in the exact order as shown in the flowchart in FIG. 3. The flowchart contains following steps:

Step 310: The tilt calibrating device 100 moves the optical pick-up head 110 to a certain location over the optical disc 101.

Step 320: The detecting areas A, B, C, D of the photo detector 120 respectively generates the detecting signals SA, SB, SC, SD according to the laser light reflected from the optical disc 101.

Step 330: The adder 145 of the combining unit 140 combines the detecting signal SA with SD, to render a combining signal (SA+SD); and the adder 155 of the combining unit 150 combines the detecting signal SB with SC, to render a combining signal (SB+SC).

Step 340: The level latching circuits 146 and 156 respectively latch the peak value (SA+SD)_{TH} of the combining signal SA+SD and the peak value (SB+SC)_{TH} of the combining signal SB+SC.

Step 350: The subtractor 162 performs subtraction between the peak value (SA+SD)_{TH} and the top value (SB+SC)_{TH}, to generate the tilt error signal Sₜᵢₗₜ_{_{—}}ₑᵣᵣₒᵣ.

Step 360: The tilt control unit 170 outputs a control signal S_{ctrl} to the actuator 180 according to the received tilt error signal Sₜᵢₗₜ_{_{—}}ₑᵣᵣₒᵣ.

Step 370: The actuator 180 adjusts the angle between the optical disc 101 and the optical pick-up head 110 according to the control value sent by the control signal S_{ctrl}.

In this preferred embodiment, the tilt calibrating device 100 can be designed to perform the tilt calibrating process before engaging the servo control based on tracking error, or can be designed to perform the tilt calibrating process after engaging the servo control based on focus error. Additionally, considering the fact that the tilt error may be different when the optical pick-up head 110 is posited at various locations on top of the track on the optical disc 101, the above-mentioned tilt calibrating device 100 can perform the tilt calibrating process respectively for various locations of the pick-up head 110 (e.g., a location on top of an inner track or an outer track of the optical disc), to obtain the control value of the control signal S_{ctrl} corresponding to these various locations of the pick-up head 110. Then, when the optical pick-up head 110 reads or writes data in the optical disc 101, the tilt control unit 170 can directly apply a previously obtained control signal S_{ctrl} for eliminating the tilt error at the time when the optical pick-up head 110 moves to a location of the optical disc 101 corresponding to said control signal S_{ctrl}. Moreover, the tilt control unit 170 can even apply interpolation upon the above-mentioned tilt error signals or the control values obtained at the location over an inner track and an outer track, so as to calculate the control values corresponding to all locations of the optical disc. By doing so, the actuator 180 can swiftly adjust the angle between the optical disc 101 and the optical pick-up head 110 according to the interpolation results, to eliminate the tilt error. Furthermore, by performing calibration process as shown in FIG. 3 and obtaining control values at even more locations on top of the optical disc (e.g., at three or five, or even more different locations on the optical disc), the accuracy of the tilt error calibration can be significantly improved.

In contrast to the conventional art, the tilt error detecting device, the tilt calibration device, and the related method of the present invention can be implemented with those basic components already present in currently widely seen optical disc drives, without the need to introduce additional optical components, for example, a dedicated tilt detector. Therefore, an increase in the hardware costs is avoided. Additionally, the tilt calibrating method of the present invention does not need to reference the RF signals; that is, the tilt calibrating method of the present invention can be applied even to a blank optical disc, or any types of optical disc, and is not limited by the examples provided herein. Moreover, the tilt error detecting device of present invention directly calculates the value of the tilt error according to a plurality of detecting signals generated by the photo detector. Therefore, the tilt error device and the related method of the present invention achieve a greater level of accuracy, sensitivity, and efficiency of tilt error calibration, which is unavailable in the prior art technology.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tilt error detecting device, for detecting a tilt error signal indicative of a tilt error between an optical disc and an optical pick-up head, the optical pick-up head comprising a photo detector for generating a plurality of detecting signals according to a light signal reflected from the optical disc, the photo detector comprising a plurality of first detecting areas located at a first side and a plurality of second detecting areas located at a second side, the tilt error detecting device comprising:
a first combining module, coupled to the photo detector, for generating a first level signal according to a first portion of the detecting signals which corresponds to the first detecting areas on the photo detector;
a second combining module, coupled to the photo detector, for generating a second level signal according to a second portion of the detecting signals which corresponds to the second detecting areas on the photo detector; and
a calculating module, coupled to the first combining module and the second combining module, for generating the tilt error signal according to the first level signal and the second level signal.

2. The tilt error detecting device of claim 1, wherein the first combining module comprises:
a first combining unit, coupled to the photo detector, for combining signals belonging to the first portion of the detecting signals to render a first combining signal; and
a first level latching circuit, coupled to the first combining unit, for latching the first level signal according to a signal level of the first combining signal; and
the second combining module comprises:
a second combining unit, coupled to the photo detector, for combining signals belonging to the second portion of the detecting signals to render a second combining signal; and
a second level latching circuit, coupled to the second combining unit, for latching the second level signal according to a signal level of the second combining signal.

3. The tilt error detecting device of claim 2, wherein the first and the second level latching circuits are hold circuits.

4. The tilt error detecting device of claim 2, wherein the first and the second level latching circuits are averaging circuits.

5. The tilt error detecting device of claim 1, wherein the calculating module is a subtractor for calculating a difference between the first level signal and the second level signal to generate the tilt error signal.

6. A tilt calibrating device, for calibrating a tilt errorbetween an optical disc and an optical pick-up head, the tilt calibrating device comprising:
a photo detector, for generating a plurality of detecting signals according to a light signal reflected from the optical disc, the photo detector comprising a plurality of first detecting areas located at a first side and a plurality of second detecting areas located at a second side;
a tilt error detecting device, coupled to the photo detector, comprising:
a first combining module, coupled to the photo detector, for generating a first level signal according to a first portion of the detecting signals which corresponds to the first detecting areas on the photo detector;
a second combining module, coupled to the photo detector, for generating a second level signal according to a second portion of the detecting signals which corresponds to the second detecting areas on the photo detector; and
a calculating module, coupled to the first combining module and the second combining module, for generating a tilt error signal according to the first level signal and the second level signal;
a tilt control unit, coupled to the calculating module, for generating a control signal according to the tilt error signal; and
an actuator, coupled to the tilt control unit, for adjusting the tilt error between the optical pick-up head and the optical disc according to the control signal.

7. The tilt calibrating device of claim 6, wherein the first combining module comprises:
a first combining unit, coupled to the photo detector, for combining signals belonging to the first portion of the detecting signals to render a first combining signal; and
a first level latching circuit, coupled to the first combining unit, for latching the first level signal according to a signal level of the first combining signal; and
the second combining module comprises:
a second combining unit, coupled to the photo detector, for combining signals belonging to the second portion of the detecting signals to render a second combining signal; and
a second level latching circuit, coupled to the second combining unit, for latching the second level signal according to a signal level of the second combining signal.

8. The tilt calibrating device of claim 7, wherein the first and the second level latching circuits are hold circuits.

9. The tilt calibrating device of claim 7, wherein the first and the second level latching circuits are averaging circuits.

10. The tilt calibrating device of claim 6, wherein the calculating module is a subtractor for calculating a difference between the first level signal and the second level signal to generate the tilt error signal.

11. A tilt error detecting method, for detecting a tilt error signal indicative of a tilt error between an optical disc and an optical pick-up head, the optical pick-up head comprising a photo detector for generating a plurality of detecting signals according to a light signal reflected from the optical disc, the photo detector comprising a plurality of first detecting areas located at a first side and a plurality of second detecting areas located at a second side, the method comprising:
(a) generating a first level signal according to a first portion of the detecting signals which corresponds to the first detecting areas on the photo detector;
(b) generating a second level signal according to a second portion of the detecting signals which corresponds to the second detecting areas on the photo detector; and
(c) generating the tilt error signal according to the first level signal and the second level signal.

12. The tilt error detecting method of claim 11, wherein step (a) further comprises:
combining signals belonging to the first portion of the detecting signals to render a first combining signal; and
latching the first level signal according to a signal level of the first combining signal; and
step (b) further comprises:
combining signals belonging to the second portion of the detecting signals to render a second combining signal; and
latching the second level signal according to a signal level of the second combining signal.

13. The tilt error detecting method of claim 11, wherein step (c) further comprises:
calculating a difference of the first level signal and the second level signal to generate the tilt error signal.

14. A tilt calibrating method, for calibrating a tilt error between an optical disc and an optical pick-up head, the optical pick-up head comprising a photo detector for generating a plurality of detecting signals according to a light signal reflected from the optical disc, the photo detector comprising a plurality of first detecting areas located at a first side and a plurality of second detecting areas located at a second side, the method comprising:
(a) generating a first level signal according to a first portion of the detecting signals which corresponds to the first detecting areas on the photo detector;
(b) generating a second level signal according to a second portion of the detecting signals which corresponds to the second detecting areas on the photo detector;
(c) generating the tilt error signal according to the first level signal and the second level signal;
(d) generating a control signal according to the tilt error signal; and
(e) adjusting the tilt error between the optical pick-up head and the optical disc according to the control signal.

15. The tilt calibrating method of claim 14, wherein step (a) further comprises:
combining signals belonging to the first portion of the detecting signals to render a first combining signal; and
latching the first level signal according to a signal level of the first combining signal; and
step (b) further comprises:
combining signals belonging to the second portion of the detecting signals to render a second combining signal; and
latching the second level signal according to a signal level of the second combining signal.

16. The tilt calibrating method of claim 14, wherein step (c) further comprises:
calculating a difference between the first level signal and the second level signal to generate the tilt error signal.
